(19) United States
(12) Patent Application Publication
(10) Pub. No.: US 2025/0015949 A1
(43) Pub. Date: Jan. 9, 2025

(54) Sounding Interval Optimization

(71) Applicant: Cisco Technology, Inc., San Jose, CA (US)

(72) Inventors: Jerome Henry, Pittsboro, NC (US); Pascal Thubert, Roquefort-les-Pins (FR); Jean Philippe Vasseur, Issy Les Moulineaux (FR); Federico Lovison, Vimercate (IT); Sukrit Dasgupta, Boxborough, MA (US)

(73) Assignee: Cisco Technology, Inc., San Jose, CA (US)

(21) Appl. No.: 18/766,451

(22) Filed: Jul. 8, 2024

Related U.S. Application Data
(60) Provisional application No. 63/512,648, filed on Jul. 9, 2023.

(51) Int. Cl. H04L 5/00; H04W 84/12

(52) U.S. Cl. CPC H04L 5/0048; H04W 84/12

(57) ABSTRACT

Optimizing or otherwise improving sounding intervals may be provided. Improving sounding intervals can include generating predicted Channel State information (CSI) of a Station (STA). A Null Data Packet (NDP) Announcement (NDPA) can be sent to the STA, wherein the NDPA instructs the STA to send compressed CSI. A reference signal is then sent to the STA. Finally, the compressed CSI is received from the STA.

### RELATED APPLICATION

Under provisions of 35 U.S.C. § 119 (e), Applicant claims the benefit of and priority to U.S. Provisional Application No. 63/512,648, filed Jul. 9, 2043, the disclosure of which is incorporated herein by reference in its entirety.

### TECHNICAL FIELD

The present disclosure relates generally to optimizing or otherwise improving sounding intervals.

### BACKGROUND

In computer networking, a wireless Access Point (AP) is a networking hardware device that allows a Wi-Fi compatible client device to connect to a wired network and to other client devices. The AP usually connects to a router (directly or indirectly via a wired network) as a standalone device, but it can also be an integral component of the router itself. Several APs may also work in coordination, either through direct wired or wireless connections, or through a central system, commonly called a Wireless Local Area Network (WLAN) controller. An AP is differentiated from a hotspot, which is the physical location where Wi-Fi access to a WLAN is available.

Prior to wireless networks, setting up a computer network in a business, home, or school often required running many cables through walls and ceilings in order to deliver network access to all of the network-enabled devices in the building. With the creation of the wireless AP, network users are able to add devices that access the network with few or no cables. An AP connects to a wired network, then provides radio frequency links for other radio devices to reach that wired network. Most APs support the connection of multiple wireless devices. APs are built to support a standard for sending and receiving data using these radio frequencies.

### BRIEF DESCRIPTION OF THE FIGURES

The accompanying drawings, which are incorporated in and constitute a part of this disclosure, illustrate various embodiments of the present disclosure. In the drawings:

FIG. 1 is a block diagram of an operating environment for sounding interval improvement in accordance with aspects of the present disclosure.

FIG. 2 is a signaling diagram of a signaling process for channel sounding in accordance with aspects of the present disclosure.

FIG. 3 is a flow chart of a method for sounding interval improvement in accordance with aspects of the present disclosure.

FIG. 4 is a block diagram of a computing device in accordance with aspects of the present disclosure.

FIG. 5 is a block diagram of a wireless device in accordance with aspects of the present disclosure.

### DETAILED DESCRIPTION

### Overview

Optimizing or otherwise improving sounding intervals may be provided. Improving sounding intervals can include generating predicted Channel State information (CSI) of a Station (STA). A Null Data Packet (NDP) Announcement (NDPA) can be sent to the STA, wherein the NDPA instructs the STA to send compressed CSI. A reference signal is then sent to the STA. Finally, the compressed CSI is received from the STA.

Both the foregoing overview and the following example embodiments are examples and explanatory only and should not be considered to restrict the disclosure's scope, as described, and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Wireless networks can be implemented in high density environments that require support for hundreds or more clients in a given area. Additionally, next generation Wi-Fi standards (e.g., the Institute of Electrical and Electronics Engineers (IEEE) 802.11bn) will likely enable the implementation of an increasing number of Spatial Streams (SSs) and other Multiple-Input Multiple-Output techniques. Improving networking functions and operation is therefore important to accommodate the large amount of traffic that can result from high density environments and Multiple-Input Multiple-Output (MIMO) techniques to ensure stable and intended network operation.

One technique for improving network operation is Channel State Information (CSI) feedback compression, which can be implemented to reduce the number of bits consumed in each subcarrier's feedback. CSI feedback compression allows for improved efficiency of the feedback matrix, and CSI feedback of a given size can therefore contain more subcarrier data than the traditional structure (e.g., as described in IEEE 802.11ax). Predicting the loss in data for compression methods can also enable Access Points (APs) and/or Stations (STAs) to choose the least-loss or otherwise preferred solution for CSI feedback compression.

Network operations improvements can also include determining whether the CSI matrix is needed at all and enabling an AP can skip requesting a CSI matrix and STAs to skip returning the CSI matrix when it is not needed. For example a Null Data Packet (NDP) response may not include any new or otherwise useful CSI compared to a previous response. Thus, an AP and/or a STA can compute not just the CSI compression, but whether there is a need for a new feedback exchange as described herein.

An AP can predict the structure of the next feedback matrix for a given STA. The confidence resulting from the prediction calculation can be used for the AP to determine whether to forego the next CSI exchange or to allow the STA to only return a partial matrix. The AP can fill in the partial matrix with expected values. This method of skipping exchanges and/or enabling the transmission of a partial matrix can save airtime while maintaining a reliable channel information between the STA and the AP.

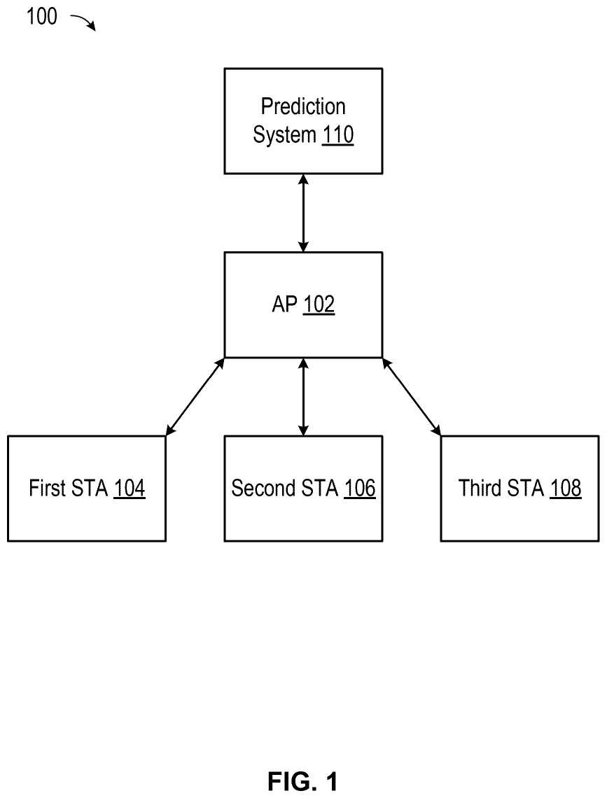

FIG. 1 is a block diagram of an operating environment 100 for sounding interval improvement. The operating environment 100 can include an AP 102, a first STA 104, a second STA 106, a third STA 108, and a prediction system 110. There may be a different number of devices in the operating environment 100 in other examples, including APs, STAs, prediction systems, and/or other network devices. For example, there may be one or more additional APs in the operating environment 100, and the AP 102 and the additional APs can function in a multi-AP coordination environment, communicating with each other to coordinate operations.

The AP 102 may enable devices within range of the AP 102 to connect to the network. The first STA 104, the second STA 106, and the third STA 108 can be any device (e.g., a smart phone, a tablet, a personal computer, a server, etc.) that connects to the network, such as to communicate with other devices on the network. The first STA 104, the second STA 106, and the third STA 108 may be physically positioned in an area covered by the AP 102.

The AP 102 and other devices of the network use channel sounding to evaluate the channel (i.e., the radio environment for wireless communication). For example, the AP 102 can perform sounding by requesting CSI from the first STA 104, the second STA 106, and/or the third STA 108. The AP 102 can use the CSI to evaluate the channel, such as determining the likelihood of success of a transmission with first STA 104, the second STA 106, and/or the third STA 108.

The AP 102 may set a timer or other value to trigger another sounding interval to re-evaluate the channel periodically. Because sounding intervals occur periodically, the sounding process will periodically use airtime and/or other resources of the network. The AP 102 and the prediction system 110 can improve sounding intervals and reduce the resources the sounding process uses by enabling the AP 102 and STAs to skip the CSI exchange during sounding intervals, enabling STAs to compress CSI, and/or the like.

The prediction system 110 may be a device that can monitor the network and process information to generate predictions, such as the stability of the channel, channel state trends, feedback matrix predictions, and/or the like. In some embodiments, the prediction system 110 is a component of the AP 102 or a controller (e.g., a Wireless Local Area Network (WLAN) controller). In some embodiments, the prediction system 110 uses machine learning and/or artificial intelligence techniques to predict channel state trends and stability, to predict the structure of future feedback matrices, to determine whether a new CSI matrix is needed and enabling the AP 102 to skip requesting a CSI matrix and STAs to skip returning the CSI matrix when it is not needed, and/or the like. The purpose of CSI feedback matrices is for the AP 102 to determine the likelihood of success of a transmission with one or more STAs, given an expected Modulation and Coding Scheme (MCS). Thus, the prediction system 110 may generate predictions for this likelihood of success and send the predictions to the AP 102.

In certain embodiments, the AP 102 and/or the prediction system 110 can utilize machine learning to improve sounding intervals as described herein. In general, machine learning is concerned with the design and the development of techniques that take data (e.g., network statistics, performance indicators) as input, and recognize complex patterns in the data. One common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used to classify new data points. Often, M is a statistical model, and the cost function is inversely proportional to the likelihood of M, given the input data.

In various implementations, the AP 102 and/or the prediction system 110 may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as being indicative of an acceptable performance or unacceptable performance. Unsupervised techniques do not require a training set of labels. While a supervised learning model may look for previously seen patterns that have been labeled as such, an unsupervised model may instead look to whether there are sudden changes or patterns in the behavior of the metrics. Semi-supervised learning models are a mixed approach that use a reduced set of labeled training data.

Example machine learning techniques that the AP 102 and/or the prediction system 110 can employ may include Nearest Neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), Support Vector Machines (SVMs), Generative Adversarial Networks (GANs), Long Short-Term Memory (LSTM), logistic or other regression, Markov models or chains, Principal Component Analysis (PCA) (e.g., for linear models), Singular Value Decomposition (SVD), Multi-Layer Perceptron (MLP) Artificial Neural Networks (ANNs) (e.g., for non-linear models), replicating reservoir networks (e.g., for non-linear models, typically for timeseries), random forest classification, and/or the like.

In further implementations, the AP 102 and/or the prediction system 110 may also use one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. Example generative approaches can include, but are not limited to, Generative Adversarial Networks (GANs), Large Language Models (LLMs), other transformer models, and/or the like.

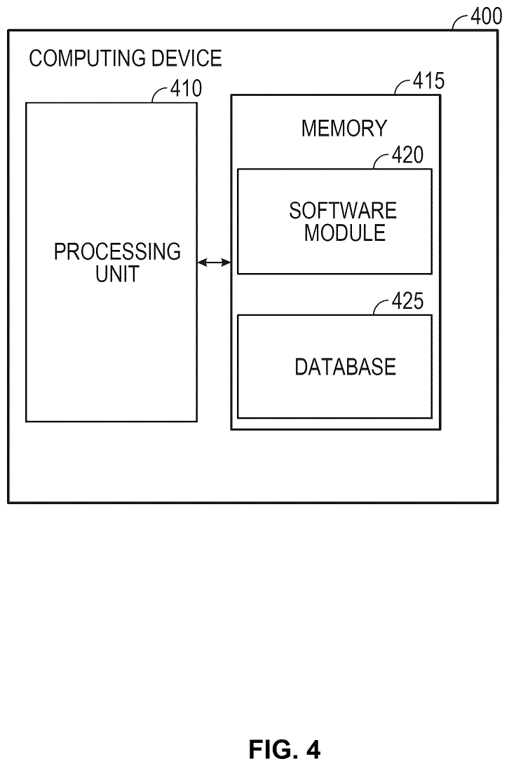

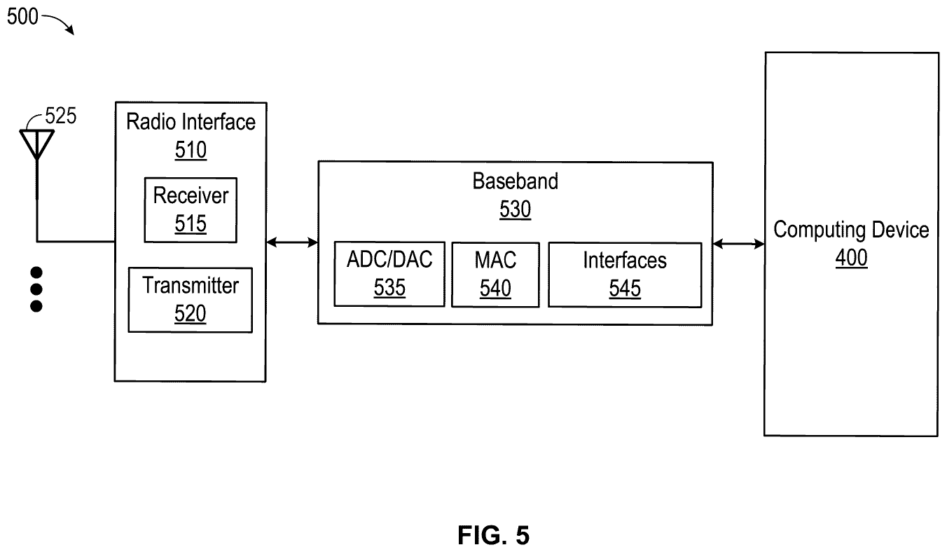

The elements described above of the operating environment 100 (e.g., the AP 102, the first STA 104, the second STA 106, the third STA 108, the prediction system 110, etc.) may be practiced in hardware, in software (including firmware, resident software, micro-code, etc.), in a combination of hardware and software, or in any other circuits or systems. The elements of the operating environment 100 may be practiced in electrical circuits comprising discrete electronic elements, packaged or integrated electronic chips containing logic gates (e.g., Application Specific Integrated Circuits (ASIC), Field Programmable Gate Arrays (FPGA), System-On-Chip (SOC), etc.), a circuit utilizing a microprocessor, or on a single chip containing electronic elements or microprocessors. Furthermore, the elements of the operating environment 100 may also be practiced using other technologies capable of performing logical operations such as, for example, AND, OR, and NOT, including but not limited to, mechanical, optical, fluidic, and quantum technologies. As described in greater detail below with respect to FIGS. 4 and 5, the elements of the operating environment 100 may be practiced in a computing device 400 and/or communications device 500.

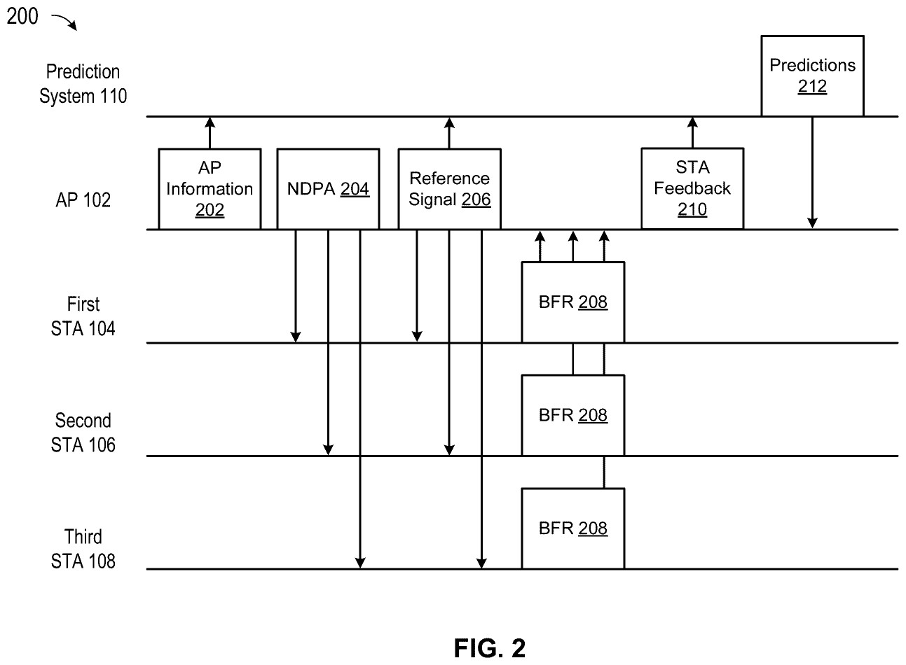

FIG. 2 is a signaling diagram of a signaling process 200 for channel sounding in accordance with aspects of the present disclosure. In some embodiments, the AP 102 begins the signaling process 200 by sending AP information 202 to the prediction system 110. The AP information 202 can include information associated with the AP 102 and its clients, such as the first STA 104, the second STA 106, and/or the third STA 108. For example, the AP information 202 can include the number of STAs associated to the AP 102, the last determined individual MCS, Received Signal Strength Indicator (RSSI), and/or Signal-to-Noise Ratio (SNR) of the STAs, last individual frames sizes and transmission and reception times of the STAs, Buffer Status Reports (BSR), previous CSI received from STAs, STA metadata, and the like. In other embodiments, the AP 102 shares the AP information 202 with the prediction system 110 before the signaling process 200 and therefore separately from any signaling associated with sounding.

To initiate channel sounding, the signaling process 200 can start with the AP 102 transmitting a Null Data Packet (NDP) Announcement (NDPA) 204 to one or more client devices (e.g., the first STA 104, the second STA 106, and/or the third STA 108). The NDPA 204 notifies the first STA 104, the second STA 106, and/or the third STA 108 that the AP 102 will transmit a reference signal 206, generally in a Short Inter-Frame Space (SIFS) after the NDPA 204. The reference signal 206 is typically a NDP frame (e.g., as described in IEEE 802.11ax). In example embodiments, the NDP can include a High Efficiency (HE)-Long Training Field 3 (LTF3) (HE-LTF3) with a duration of 7.2, 8, or 16 microseconds for each SS. The AP 102 can also forward the reference signal 206 to the prediction system 110 for the prediction system 110 to use, for example to determine whether a feedback matrix from one or more STAs is needed and/or whether one or more STAs can send a compressed or otherwise incomplete feedback matrix.

In some embodiments, one or more of the STAs can leverage CSI feedback compression. STAs for example may be capable of utilizing artificial intelligence and machine learning techniques and/or have capabilities as described in the IEEE 802.11bn standard to compress CSI. The AP 102 can send a new type of NDPA 204 that indicates the confidence level of the prediction system's 110 and/or the AP's 102 prediction of the next CSI feedback, and the STA can determine to send a compressed CSI feedback matrix based on the confidence level. In other example implementations, the AP 102 may indicate to the STA to send a compressed CSI feedback matrix via the NDPA 204. In yet additional example implementations, the AP 102 may send a suggested compression ratio, a loss ratio, a sample ratio, or another indication of the simplification that the STA can use for generating a CSI feedback matrix.

Once the reference signal 206 is received, the first STA 104, the second STA 106, and/or the third STA 108 can reply with Beamforming Reports (BFRs) 208 that include CSI either sequentially or in parallel using Orthogonal Frequency Division Multiple Access (OFDMA) uplinks. For example, the first STA 104, the second STA 106, and/or the third STA 108 can use the reference signal 206 to generate information about the received signals and respond by sending CSI to the AP 102. The BFRs 208 may comprise a compressed or otherwise incomplete feedback matrix in some examples. In some embodiments, the STAs may respond with other frame types, but the STA responses will be referred to as BFRs 208 herein for simplicity and clarity.

The first STA 104, the second STA 106, and/or the third STA 108 may send the BFRs 208 in a particular order or when the BFR 208 is generated and ready to send. In some examples, the first STA 104, the second STA 106, and/or the third STA 108 send the BFRs 208 in a SIFS after the reference signal 206. In some embodiments, when multiple STAs are involved in the sounding process, the AP 102 may send a trigger frame to indicate when the first STA 104, the second STA 106, and/or the third STA 108 should send the BFRs 208. The trigger frame may be a BFR Poll (BFRP) trigger frame in some example implementations. The STAs can identify that multiple STAs are involved in the sounding process when there are multiple STA information fields in the NDPA 204, and the STAs can then wait to send the BFRs 208 until receiving the trigger frame. The STAs can send the BFRs 208 in a SIFS after the trigger frame in some examples. Additionally, one or more rounds of the trigger frame and the transmission of BFRs 208 can occur if there are more STAs than a maximum number of stations that can be supported by uplink multi-user transmission.

When an STA determines to compress the CSI feedback matrix, for example based on the NDPA 204 or is otherwise instructed by the AP 102, the STA can responds with a compressed or an incomplete matrix via the BFR 208. In some embodiments, the compression may be lossy, and the AP 102 can recompose a percentage of the matrix. In further embodiments, the STA can return a smaller matrix that only represents the CSI on some of the subcarriers. The AP 102 can compare the received matrix to the matrix predicted by the prediction system 110 and fill in missing subcarriers in the received matrix based on the predicted matrix.

Once the AP 102 receives the BFRs 208 from each STA involved in the sounding process, the AP 102 may send STA feedback 210 to the prediction system 110. The STA feedback 210 can include any information the AP 102 receives in the BFRs 208, such as CSI and feedback matrices. In some embodiments, the AP 102 may send the AP information 202 with the prediction system 110 when sending the STA feedback 210 if the AP 102 has not already done so or the AP information 202 has changed. For example, the signaling process 200 may be the first sounding process for one or more STAs while associating with the AP 102, so the AP information 202 may change.

The prediction system 110 can use the STA feedback 210, the AP information 202, the reference signal 206, and/or other information to generate predictions 212 and send the predictions 212 to the AP 102. The predictions 212 can include the prediction system 110 determining whether the AP 102 and STAs can skip the exchange for one or more future CSI feedback matrices, whether STAs can compress the CSI feedback matrices, predicted CSI feedback matrices, and/or the like. For example, the prediction system 110 can use time series-based mechanisms to evaluate the stability of the channel. In some embodiments, the prediction system 110 uses an amount of previous CSI feedback matrices from the same STA (e.g., the three previous CSI feedback matrices, the five previous CSI feedback matrices, the ten previous CSI feedback matrices, etc.) and uses trajectory determination techniques (e.g. Lyapunov exponent) to determine the likelihood that the channel state will continue toward the same trend. The channel state for example can have a trend to remain stable, degrade, or improve. The prediction system 110 may efficiently predict the channel state trend using three samples (i.e., the three previous CSI feedback matrices of a given STA) using the Lyapunov exponent techniques for example.

In certain embodiments, the prediction system 110 observes the changes in the information associated with the STAs in the cell (e.g., STAs within range of the AP 102) and predicts the next feedback matrix for a given STA based on the changes in the information. The information can comprise changes to the AP information 202, including changes to the CSI feedback matrices, and/or the like. The prediction system 110 may use the changes in the information associated with other STAs to predict changes in the feedback matrix of a target STA. For example, the prediction system 110 can use gradient booster techniques, in combination with tree algorithms, to determine how the changes in the information of other STAs may imply a change in the feedback matrix of a target STA. For a given STA (e.g., the first STA 104), at a given RSSI, MCS, and/or SNR to the AP 102, and a given set of other STAs (e.g., the second STA 106 and the third STA 108) and their associated traffic, the prediction system 110 can output the likelihood of a combination for the next feedback matrix, the flatness of the signal, the CSI peak/trough count, and variation across the channel (indicative of the channel stability).

The prediction system 110 can use the predicted channel state trend, the predicted feedback matrix, and/or the like to determine whether new CSI is needed from an STA and/or whether the STA can send compressed CSI (e.g., a compressed feedback matrix). The prediction system 110 may additionally determine which types of compression will work best or are otherwise preferred for the compressed CSI, for example based on the channel state, the characteristics of the AP 102, the characteristics of the respective STA, and/or the like. The prediction system 110 can make predictions for any STA associated with the AP 102, such as the first STA 104, the second STA 106, and the third STA 108, and/or for other APs of the network.

The signaling process 200 can occur indefinitely as sounding intervals occur (e.g., as set by the AP 102), with the AP 102 sending the NDPA 204 and the reference signal 206, STAs responding with BFRs 208, the AP 102 providing STA feedback 210, and the prediction system 110 sending predictions 212. During sounding intervals, the AP 102 may skip sending the NDPA 204 and/or the reference signal 206 to one or more STAs and the STAs may skip sending the BFR 208 when the prediction system 110 can generate predicted CSI or the CSI is otherwise not needed. Some STAs may also send compressed CSI based on the predictions 212 of the prediction system 110.

The prediction system 110 may be trained before being implemented in a network for improving sounding, such as by enabling the AP 102 and STAs to skip the exchange to receive CSI or enabling STAs to send compressed CSI. In a training phase, the prediction system 110 can compare the a received CSI report to a predicted report the prediction system 110 generates. The prediction system 110 uses the comparison to improve its future prediction, such as by improving the gradients parameters. The prediction system 110 may monitor its performance predicting the CSI report and will not provide predictions to the AP 102 while the prediction system 110 does not generate predictions with acceptable accuracy, such as above a threshold confidence level. Thus, the typical CSI signal exchanges for receiving CSI would continue while the prediction system 110 is training. For example, the prediction system 110 may enter the training phase when the prediction system 110 is newly introduced to the operating environment or the prediction system 110 may identify its past predictions are not above the threshold confidence level. Once the prediction system 110 reaches a sufficient prediction reliability (e.g., generating predictions above the confidence threshold). the prediction system 110 can begin providing predictions to the AP 102.

In some embodiments, the AP 102 and/or the prediction system 110 may determine that the prediction system 110 is generating acceptable predictions, and the AP 102 may skip the process for receiving CSI (e.g., the exchange of the NDPA 204, the reference signal 206, and the BFR(s) 208) every other sounding interval, in some other pattern, or according to a recommendation from the prediction system 110 (e.g., based on predicted changes to channel state, STA characteristics such as position, etc.). In some example implementations, the AP 102 may receive from the prediction system 110 a predicted CSI matrix for the periods the process for receiving CSI is skipped. In some example implementations, the AP 102 can send a NDPA 204 that identifies, based on the predictions 212 for example, any STAs that can skip sending CSI (e.g., skip sending the BFR 208), any STAs that can send compressed CSI, and any STAs that should send uncompressed CSI.

The AP 102 can use the results of compressed CSI feedback matrix completed using a predicted feedback matrix to determine the next NDPA 204 query, such as sending the confidence level of the predictions, instructing the STA to send compressed CSI, the type of compression to use, a suggested compression ratio, a loss ratio, a sample ratio, another indication of the simplification that the STA can make for its CSI feedback matrix, whether to skip sending the CSI feedback matrix, and/or the like, in some embodiments. In other embodiments, the AP 102 can notify the STA when there is sufficient a success ratio for employing the compression the STA used (e.g., measured by the predicted matrix compared to the samples returned). STAs can use the notification to determine which compression algorithms can be used and to validate queries from the AP 102. In certain embodiments, when the compressed CSI matrix the AP 102 receives diverges from the predicted CSI feedback matrix of the prediction system 110, the AP 102 can send a new NDPA 204 to the respective STA to request additional samples and/or for the STA to use a different compression method for future CSI exchanges (e.g., to obtain more of the missing subcarrier's feedback). In some embodiments, the AP 102 uses the predictions 212 of the prediction system 110 to determine the number of CSI exchanges (e.g., the NDPA 204, the reference signal 206, and the BFR 208) to skip, and, upon performing the next exchange, uses the prediction accuracy to determine the compression and/or loss level that is acceptable for the CSI feedback.

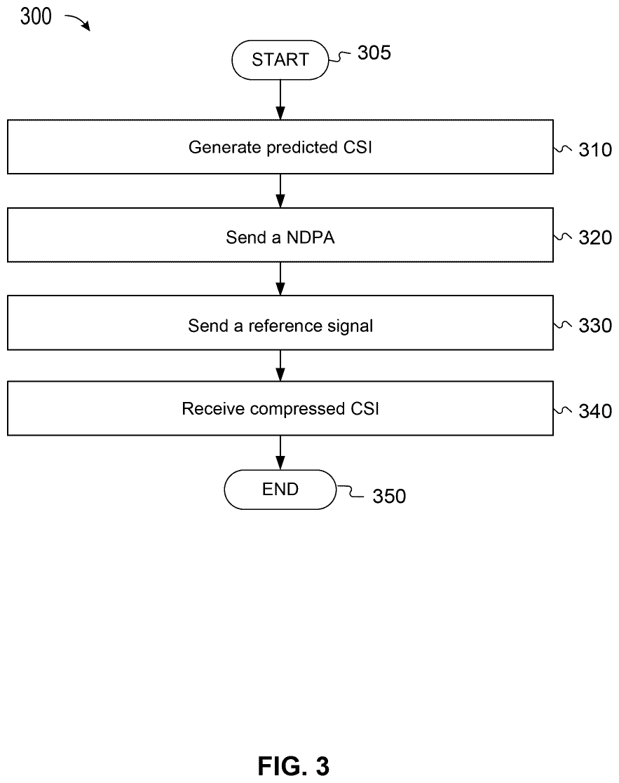

FIG. 3 is a flow chart of a method 300 for sounding interval improvement. The method 300 may begin at starting block 305 and proceed to operation 310. In operation 310, predicted CSI is generated. For example, the AP 102 and/or the prediction system 110, may generate predicted CSI for one or more STAs (e.g., the first STA 104, the second STA 106, the third STA 108). The predicted CSI may comprise a predicted CSI feedback matrix. Generating the predicted CSI can include the prediction system 110 generating predictions as described herein. For example, the prediction system 110 can determine a channel state trend using an amount of previous CSI from the STA and trajectory determination techniques, and the prediction system 110 can predict the CSI based on the channel state trend. The prediction system 110 can additionally or instead predict the CSI based on changes in information associated with other STAs in a cell as described herein.

In operation 320, a NDPA is sent to a STA. For example, the AP 102 sends the NDPA 204 to one or more of the STAs (the first STA 104, the second STA 106, the third STA). The NDPA 204 may notify the STA that the AP 102 will send a reference signal 206, instruct the STA to send compressed CSI, indicate the confidence level of the prediction system's 110 and/or the AP's 102 prediction of the next CSI feedback, and/or the like.

In operation 330, a reference signal is sent to the STA. For example, the AP 102 sends the reference signal 206 to one or more STAs. The one or more STAs can use the reference signal 206 to generate CSI for replying to the AP 102 (e.g., BFRs 208). In some embodiments, the AP 102 also sends or otherwise shares the reference signal 206 with the prediction system 110.

In operation 340, the compressed CSI is received from the STA. For example, the AP 102 receives compressed CSI from the one or more STAs. The AP 102 may use predictions (e.g., the predictions 212) of the prediction system 110 to determine any missing information of the compressed CSI. The compressed CSI may comprise a compressed feedback matrix in some embodiments.

In some embodiments, the method 300 further comprises the AP 102 determining to send additional NDPAs to the one or more STAs every other subsequent sounding interval and skip sending additional NDPAs to the one or more STAs for the remaining sounding intervals. Thus, the AP 102 only sends an NDPA 204 every other sounding interval. The AP 102 may send an NDPA 204 in different patterns in other example implementations.

In certain embodiments, the method 300 can include the AP 102 and/or the prediction system 110 comparing the predicted CSI and the compressed CSI to evaluate the predicted CSI. The AP 102 and/or the prediction system 110 can use the evaluation of the predicted CSI to generate a new NDPA (e.g., instructing STAs to compress CSI, alter the compression techniques used, skip sending CSI, etc.), send the evaluation to one or more STAs, determine a number of sounding intervals to skip sending additional NDPAs, evaluate the compression and loss level of the compressed CSI, and/or the like. The method 300 may conclude at ending block 350.

FIG. 4 is a block diagram of a computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for sounding interval improvement with respect to FIG. 1, FIG. 2, and FIG. 3. Computing device 400, for example, may provide an operating environment for the AP 102, the first STA 104, the second STA 106, the third STA 108, the prediction system 110, and the like. The AP 102, the first STA 104, the second STA 106, the third STA 108, the prediction system 110, and the like may operate in other environments and are not limited to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples, and computing device 400 may comprise other systems or devices.

FIG. 5 illustrates an implementation of a communications device 500 that may implement one or more of the AP 102, the first STA 104, the second STA 106, the third STA 108, the prediction system 110, controllers, etc., of FIGS. 1-3. In various implementations, the communications device 500 may comprise a logic circuit. The logic circuit may include physical circuits to perform operations described for one or more of the AP 102, the first STA 104, the second STA 106, the third STA 108, the prediction system 110, controllers, etc., of FIGS. 1-3, for example. As shown in FIG. 5, the communications device 500 may include one or more of, but is not limited to, a radio interface 510, baseband circuitry 530, and/or the computing device 400.

The communications device 500 may implement some or all of the structures and/or operations for the AP 102, the first STA 104, the second STA 106, the third STA 108, the prediction system 110, controllers, etc., of FIGS. 1-3, storage medium, and logic circuit in a single computing entity, such as entirely within a single device. Alternatively, the communications device 500 may distribute portions of the structure and/or operations using a distributed system architecture, such as a client station server architecture, a peer-to-peer architecture, a master-slave architecture, etc.

A radio interface 510, which may also include an Analog Front End (AFE), may include a component or combination of components adapted for transmitting and/or receiving single-carrier or multi-carrier modulated signals (e.g., including Complementary Code Keying (CCK), Orthogonal Frequency Division Multiplexing (OFDM), and/or Single-Carrier Frequency Division Multiple Access (SC-FDMA) symbols), although the configurations are not limited to any specific interface or modulation scheme. The radio interface 510 may include, for example, a receiver 515 and/or a transmitter 520. The radio interface 510 may include bias controls, a crystal oscillator, and/or one or more antennas 525. In additional or alternative configurations, the radio interface 510 may use oscillators and/or one or more filters, as desired.

The baseband circuitry 530 may communicate with the radio interface 510 to process, receive, and/or transmit signals and may include, for example, an Analog-To-Digital Converter (ADC) for down converting received signals with a Digital-To-Analog Converter (DAC) 535 for up converting signals for transmission. Further, the baseband circuitry 530 may include a baseband or PHYsical layer (PHY) processing circuit for the PHY link layer processing of respective receive/transmit signals. Baseband circuitry 530 may include, for example, a Media Access Control (MAC) processing circuit 540 for MAC/data link layer processing. Baseband circuitry 530 may include a memory controller for communicating with MAC processing circuit 540 and/or a computing device 400, for example, via one or more interfaces 545.

In some configurations, PHY processing circuit may include a frame construction and/or detection module, in combination with additional circuitry such as a buffer memory, to construct and/or deconstruct communication frames. Alternatively or in addition, MAC processing circuit 540 may share processing for certain of these functions or perform these processes independent of PHY processing circuit. In some configurations, MAC and PHY processing may be integrated into a single circuit.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on, or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the element illustrated in FIG. 1 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

1. A method comprising:
generating predicted Channel State information (CSI) of a Station (STA);
sending a Null Data Packet (NDP) Announcement (NDPA) to the STA, wherein the NDPA instructs the STA to send compressed CSI;
sending a reference signal to the STA; and
receiving the compressed CSI from the STA.

2. The method of claim 1, wherein:
the predicted CSI comprises a predicted feedback matrix; and
the compressed CSI comprises a compressed feedback matrix.

3. The method of claim 1, further comprising:
determining to send additional NDPAs to the STA every other subsequent sounding interval and skip sending additional NDPAs to the STA for remaining sounding intervals.

4. The method of claim 1, wherein generating predicted CSI of STA comprises any one of:
(i) determining a channel state trend using an amount of previous CSI from the STA and trajectory determination techniques, and predicting the predicted CSI based on the channel state trend;
(ii) predicting the predicted CSI based on changes in information associated with other STAs in a cell; or
(iii) a combination of (i) and (ii).

5. The method of claim 1, further comprising:
comparing the predicted CSI and the compressed CSI to evaluate the predicted CSI; and
generating a new NDPA based on the evaluation of the predicted CSI.

6. The method of claim 1, further comprising:
comparing the predicted CSI and the compressed CSI to evaluate the predicted CSI; and
sending the evaluation of the predicted CSI to the STA.

7. The method of claim 1, further comprising:
determining the predicted CSI differs from the compressed CSI; and
sending a new NDPA to the STA, wherein the new NDPA comprises any one of (i) a request for additional samples, or (ii) a request for a new compressed CSI.

8. The method of claim 1, further comprising:
comparing the predicted CSI and the compressed CSI to evaluate the predicted CSI; and
based on the evaluation of the predicted CSI:
determining a number of sounding intervals to skip sending additional NDPAs to the STA, and
evaluating a compression and loss level of the compressed CSI.

9. A system comprising:
a memory storage; and
a processing unit coupled to the memory storage, wherein the processing unit is operative to:
generate predicted Channel State information (CSI) of a Station (STA);
send a Null Data Packet (NDP) Announcement (NDPA) to the STA, wherein the NDPA instructs the STA to send compressed CSI;
send a reference signal to the STA; and
receive the compressed CSI from the STA.

10. The system of claim 9, wherein:
the predicted CSI comprises a predicted feedback matrix; and
the compressed CSI comprises a compressed feedback matrix.

11. The system of claim 9, the processing unit being further operative to:
determine to send additional NDPAs to the STA every other subsequent sounding interval and skip sending additional NDPAs to the STA for remaining sounding intervals.

12. The system of claim 9, wherein to generate predicted CSI of STA comprises any one of:
(i) to determine a channel state trend using an amount of previous CSI from the STA and trajectory determination techniques, and predicting the CSI based on the channel state trend;
(ii) to predict the predicted CSI based on changes in information associated with other STAs in a cell; or
(iii) a combination of (i) and (ii).

13. The system of claim 9, the processing unit being further operative to:
compare the predicted CSI and the compressed CSI to evaluate the predicted CSI; and
generate a new NDPA based on the evaluation of the predicted CSI.

14. The system of claim 9, the processing unit being further operative to:
compare the predicted CSI and the compressed CSI to evaluate the predicted CSI; and
based on the evaluation of the predicted CSI, determine a number of sounding intervals to skip sending additional NDPAs to the STA.

15. A non-transitory computer-readable medium that stores a set of instructions which when executed perform a method executed by the set of instructions comprising:
generating predicted Channel State information (CSI) of a Station (STA);
sending a Null Data Packet (NDP) Announcement (NDPA) to the STA, wherein the NDPA instructs the STA to send compressed CSI;
sending a reference signal to the STA; and
receiving the compressed CSI from the STA.

16. The non-transitory computer-readable medium of claim 15, wherein:
the predicted CSI comprises a predicted feedback matrix; and
the compressed CSI comprises a compressed feedback matrix.

17. The non-transitory computer-readable medium of claim 15, the method executed by the set of instructions further comprising:
determining to send additional NDPAs to the STA every other subsequent sounding interval and skip sending additional NDPAs to the STA for remaining sounding intervals.

18. The non-transitory computer-readable medium of claim 15, wherein generating predicted CSI of STA comprises any one of:
(i) determining a channel state trend using an amount of previous CSI from the STA and trajectory determination techniques, and predicting the predicted CSI based on the channel state trend;
(ii) predicting the predicted CSI based on changes in information associated with other STAs in a cell; or
(iii) a combination of (i) and (ii).

19. The non-transitory computer-readable medium of claim 15, the method executed by the set of instructions further comprising:
comparing the predicted CSI and the compressed CSI to evaluate the predicted CSI; and
generating a new NDPA based on the evaluation of the predicted CSI.

20. The non-transitory computer-readable medium of claim 15, the method executed by the set of instructions further comprising:
comparing the predicted CSI and the compressed CSI to evaluate the predicted CSI; and
based on the evaluation of the predicted CSI, determining a number of sounding intervals to skip sending additional NDPAs to the STA.
